(19) United States
(12) Patent Application Publication
(10) Pub. No.: US 2025/0225623 A1
(43) Pub. Date: Jul. 10, 2025

(54) METHOD OF IMAGE FUSION AND DEVICE THEREOF

(71) Applicant: MEDIATEK INC., Hsinchu City (TW)

(72) Inventors: Chi-Cheng Ju, Hsinchu City (TW); Ying-Jui Chen, Hsinchu City (TW); Jing-Ying Chang, Hsinchu City (TW); Shan-Lung Chao, Hsinchu City (TW); Chao-Chung Cheng, Hsinchu City (TW); Te-Hung Lu, Hsinchu City (TW)

(73) Assignee: MEDIATEK INC., Hsinchu City (TW)

(21) Appl. No.: 19/093,287

(22) Filed: Mar. 28, 2025

Related U.S. Application Data
(63) Continuation-in-part of application No. 18/637,468, filed on Apr. 17, 2024.
(60) Provisional application No. 63/496,439, filed on Apr. 17, 2023.

(51) Int. Cl. G06T 5/50; G06T 5/92; H04N 7/01; H04N 23/73; H04N 23/741

(52) U.S. Cl. CPC G06T 5/50; G06T 5/92; H04N 7/0127; G06T 2207/10144; G06T 2207/20208; G06T 2207/20221; H04N 23/73; H04N 23/741

(57) ABSTRACT

An image fusion method includes receiving a first image stream with a first frame rate, receiving a second image stream with a second frame rate, and fusing a first reused image frame of the first image stream with a set of second image frames of the second image stream respectively for outputting a set of fused image frames. At least one image frame of the first image stream has a timing offset from at least one corresponding image frame of the second image stream.

### CROSS REFERENCE TO RELATED APPLICATION

This application is a continuation-in-part of U.S. application Ser. No. 18/637,468, filed on Apr. 17, 2024, which claims the benefit of U.S. Provisional Application No. 63/496,439, filed on Apr. 17, 2023. The contents of these applications are incorporated herein by reference.

### BACKGROUND

The conventional high dynamic range (HDR) video technology based on multiple frame fusion is designed to fuse multiple frames with different exposure setting for producing one output frame, and the multiple frames are from image streams with the same frame rate. For example, one image stream has a plurality of first input frames marked as F1(1), F1(2), . . . , F1(N), and another image stream has a plurality of second input frames marked as F2(1), F2(2), . . . , F2(N). The aforementioned two image streams have the same frame rate. Each of the first input frames and one corresponding frame of the second input frames are merged to generate a plurality of output frames marked as O(1), O(2), . . . , O(N). Therefore, the number of the input frames being 2N is required to generate the output frames with the number of N. The large number of the input frames causes higher power consumption during sensing, transmission or storing procedures, so design of a multiple image fusion method capable of reducing a number of the input frame in image fusion is an important issue in the HDR video technology.

### SUMMARY

An embodiment provides an image fusion method. The method comprises receiving a first image stream with a first frame rate, receiving a second image stream with a second frame rate, and fusing a first reused image frame of the first image stream with a set of second image frames of the second image stream respectively for outputting a set of fused image frames. At least one image frame of the first image stream has a timing offset from at least one corresponding image frame of the second image stream.

An embodiment provides an image fusion device comprising one or more processors. The one or more processors are configured to receive a first image stream with a first frame rate, receive a second image stream with a second frame rate, and fuse a first reused image frame of the first image stream with a set of second image frames of the second image stream respectively for outputting a set of fused image frames. At least one image frame of the first image stream has a timing offset from at least one corresponding image frame of the second image stream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an operation device according to an embodiment of the present invention.

FIG. 2 is a flow chart of an asymmetric image fusion method according to the embodiment of the present invention.

FIG. 3 is a diagram of showing the image streams with different frame rates and different exposure settings according to a first embodiment of the present invention.

FIG. 4 is a diagram of showing the image streams with different frame rates and different exposure settings according to a second embodiment of the present invention.

FIG. 5 is a diagram of showing the image streams with different frame rates and different exposure settings according to a third embodiment of the present invention.

FIG. 6 is a diagram of showing the image streams with different frame rates and different exposure settings according to a fourth embodiment of the present invention.

FIG. 7 is a diagram of showing the image streams with different frame rates and different exposure settings according to a fifth embodiment of the present invention.

FIG. 8 is a diagram of showing the image streams with different frame rates and different exposure settings according to an embodiment of the present invention.

### DETAILED DESCRIPTION

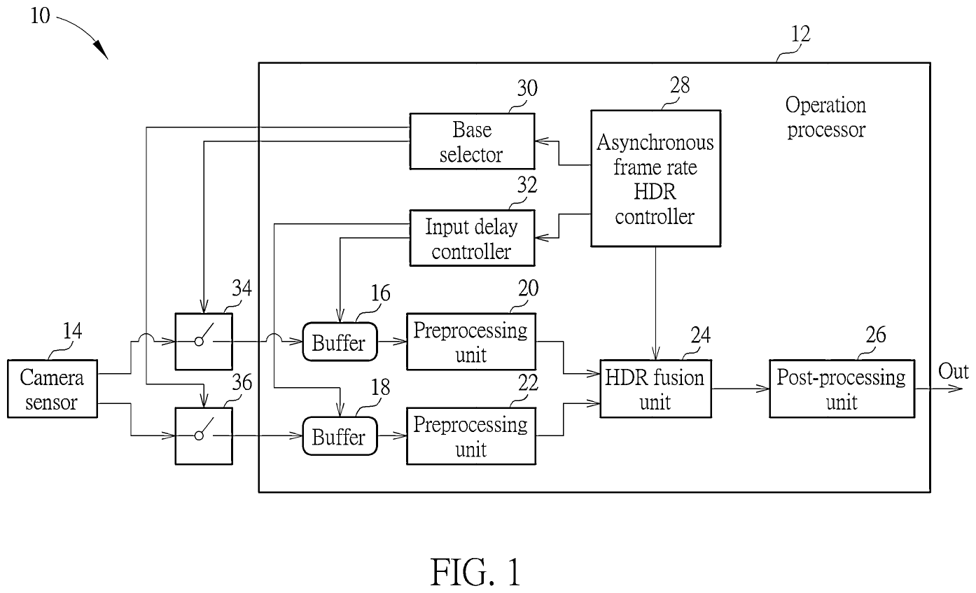

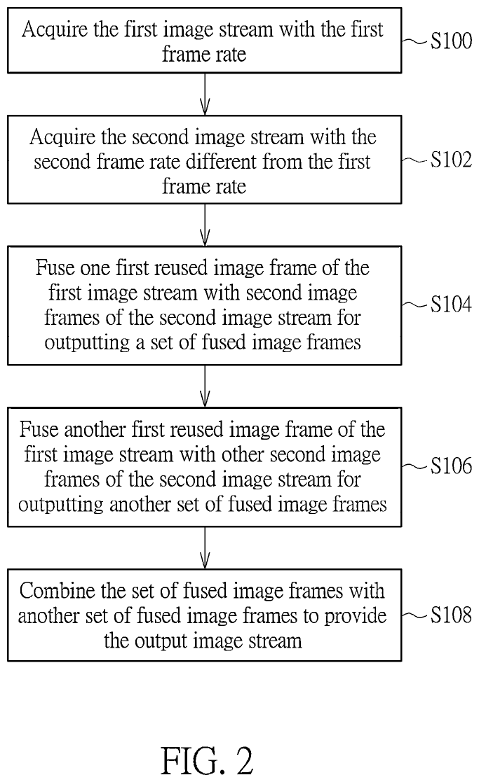

Please refer to FIG. 1 and FIG. 2. FIG. 1 is a functional block diagram of an operation device 10 according to an embodiment of the present invention. FIG. 2 is a flow chart of an asymmetric image fusion method according to the embodiment of the present invention. The operation device 10 can include an operation processor 12 electrically connected to a camera sensor 14 in a wired manner or in a wireless manner. The operation device 10 can utilize image streams captured by the camera sensor 14 to execute the asymmetric image fusion method illustrate in FIG. 2. In other possible embodiment, the operation device 10 may be a built-in unit of the camera sensor 14. Application of the operation device 10 and the camera sensor 14 can depend on a design demand.

The camera sensor 14 can be one or several high-speed camera sensors that can capture frames in high speed, or can be a group exposure setting camera sensor that has group exposure setting designed for HDR; types of the camera sensor 14 are not limited to the foresaid embodiment, and depends on the design demand. The camera sensor 14 can provide a plurality of image streams (or called streams with multiple images or video streams) with different frame rates and different exposure settings. The different exposure settings may be different exposure time or different sensor gains, which depends on the design demand. The longer exposure time or the higher sensor gain can cause a bright area within the image frame be clipped in a sensor output value range. The shorter exposure time or the lower sensor gain can cause a low signal to noise ratio (S/N) in a dark area within the image frame.

Therefore, the operation processor 12 can execute the asymmetric image fusion method to fuse the plurality of image streams with different frame rates and different exposure settings by reusing some image frames of the image streams, so as to output an output image stream or stream with images or video stream via HDR technology, for providing advantages of reducing a number of the captured image frames and economizing power consumption of sensing, transmission or storing the captured image frames. In the embodiment, the exposure settings of the image streams with different frame rates can be dynamically controlled by an auto-exposure algorithm, so the exposure setting of each image stream may not have a fixed value.

In an example of the camera sensor 14 providing two image streams with different frame rates and different exposure settings, the operation processor 12 may optionally have buffers 16 and 18, preprocessing units 20 and 22, a HDR fusion unit 24, a post-processing unit 26, an asynchronous frame rate HDR controller 28, a base selector 30 and an input delay controller 32. The buffers 16 and 18 can be used to change an image read rate. The preprocessing units 20 and 22, the HDR fusion unit 24 and the post-processing unit 26 can be applied according to standard HDR process. The asynchronous frame rate HDR controller 28 can be designed to adjust the frame rate of the image stream output by the camera sensor 14. The base selector 30 can be designed to control different exposure settings of the switches 34 and 36 at every point of times. The input delay controller 32 can be designed to control a delayed period of each image stream through the buffer 16 and/or 18.

In the present invention, one of the two image streams can have a base exposure setting, and the other image stream can have a reference exposure setting. The image stream with the base exposure setting can produce required motion of the output image stream, such as the child running, the tree swinging, the camera panning, and so on. The frame rate of the image stream with the base exposure setting can be fixed to keep the same as a display speed of the output image stream. The frame rate of the image stream with the reference exposure setting can be reduced to reduce the power consumption (in other words, the frame rate of the image stream with the reference exposure setting is set to be less than the frame rate of the display speed of the output image stream). It should be mentioned that the frame rate of the image stream with the reference exposure setting does not need to be kept uniform, and can be changed in accordance with a reduction goal of the power consumption.

In some specific condition, the base exposure setting of one image stream can be changed to the reference exposure setting, and the reference exposure setting of the other image stream can be changed to the base exposure setting via the asymmetric image fusion method of the present invention, because the base exposure setting can be controlled according to the scenes or recording purposes. For example, the image stream that has long exposure frame (with the longer exposure time or the higher sensor gain) can be set as the base exposure setting when the camera sensor 14 needs the better S/N; an external motion sensor may be used to compensate motion between the long exposure frame and short exposure frame. Or, the image stream that has the short exposure frame (with the shorter exposure time or the lower sensor gain) can be set as the base exposure setting when the camera sensor 14 is used in the mobile phone for recording the child running.

The foresaid example introduces the 2-exposure fusion, and an actual application is not limited to the 2-exposure fusion and can be expanded to the 3-exposure fusion. In other example of the camera sensor 14 providing three or more than three image streams with different frame rates and different exposure settings, one of the image streams that has the base exposure setting can have the frame rate identical to the display speed of the output image stream, and other image streams having the reference exposure setting can have the frame rate different from the display speed of the output image stream.

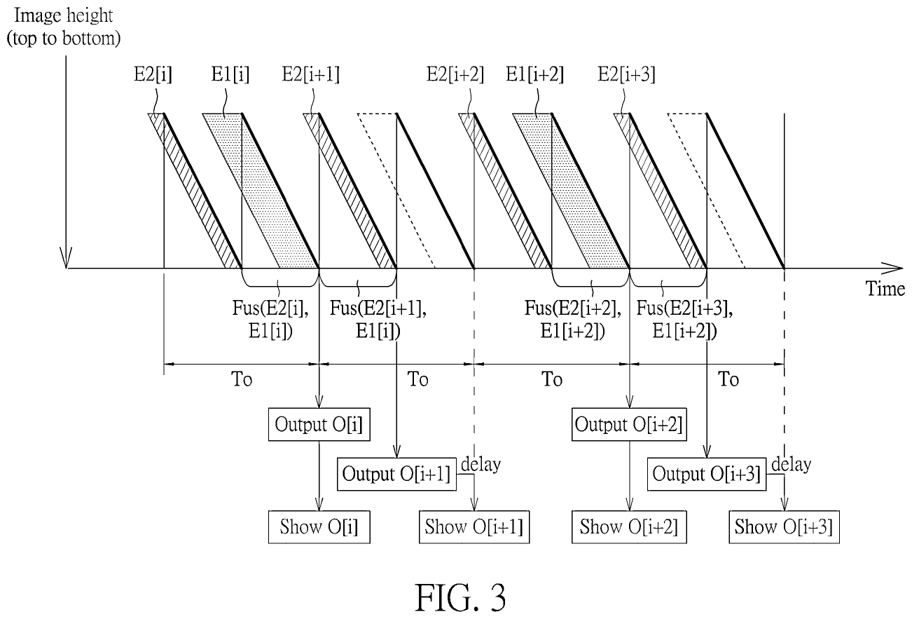

Please refer to FIG. 2 and FIG. 3. FIG. 3 is a diagram of showing the image streams with different frame rates and different exposure settings according to a first embodiment of the present invention. The first embodiment can be applied for the high-speed camera sensor 14, and interleaved control of the exposure settings can satisfy frame requirement input by the HDR video technology. For the asymmetric image fusion method, step S100 and step S102 can be executed to acquire a first image stream E1 with a first frame rate and a second image stream E2 with a second frame rate different from the first frame rate. In the first embodiment, the second image stream E2 can be set as the base exposure setting, and the second frame rate of the second image stream E2 can be equal to an output frame rate of the output image stream O. Parameter i can be indicated as the i-th image frame in the image stream. Therefore, an exposure setting of the first image stream E1 can be the reference exposure setting different from the base exposure setting of the second image stream E2.

Then, step S104 can be executed to fuse a first reused image frame E1[i] of the first image stream E1 with a set of second image frames E2[i] and E2[i+1] of the second image stream E2 respectively for outputting a set of fused image frames O[i] and O[i+1]. After that, step S106 and step S108 can be executed to fuse another first reused image frame E1[i+2] of the first image stream E1 with another set of second image frames E2[i+2] and E2[i+3] of the second image stream E2 respectively for outputting another set of fused image frames O[i+2] and O[i+3], and further to combine the fused image frames O[i] and O[i+1] with the fused image frames O[i+2] and O[i+3] to provide the output image stream O. The first reused image frame E1[i] and the first reused image frame E1[i+2] are both from the first image stream E1, so that a reused frequency of the first reused image frame E1[i] can be the same as a reused frequency of the another first reused image frame E1[i+2], and can be represented as the first image stream E1 has the stable first frame rate.

As the first embodiment shown in FIG. 3, the tilted line from top to bottom can be interpreted as exposure time of each image frame, so that a parameter To can indicate a time difference from the beginning of each second image frame E2 to the end of the related first reused image frame E1. The first reused image frame E1[i] can be fused with a current second image frame E2[i] to output and immediately show the current fused image frame O[i], and the first reused image frame E1[i] can be further fused with a following second image frame E2[i+1] to output the following fused image frame O[i+1], and the following fused image frame O[i+1] can be delayed for a predefined period to show so as to keep the fused image frames O[i] and O[i+1] are shown in uniform time interval.

Accordingly, the first reused image frame E1[i+2] can be fused with the current second image frame E2[i+2] to output and immediately show the current fused image frame O[i+2], and the first reused image frame E1[i+2] can be further fused with the following second image frame E2[i+3] to output the following fused image frame O[i+3], and the following fused image frame O[i+3] can be delayed for the predefined period to show so as to keep the fused image frames O[i+2] and O[i+3] are shown in the uniform time interval. The predefined period may be computed as time difference between an ending point of time of the first reused image frame E1[i] and an ending point of time of the current second image frame E2[i]. The first image stream E1 can have less image frames than the second image stream E2.

If the first embodiment is applied to the 3-exposure fusion, the asymmetric image fusion method can further acquire a third image stream with a third frame rate different from the first frame rate of the first image stream E1 and the second frame rate of the second image stream E2. When the second image stream E2 is still set as the base exposure setting, the first reused image frame of the first image stream E1 and a third reused image frame of the third image stream can be fused with the second image frames of the second image stream E2 respectively to output the fused image frames, and a reused frequency of the first reused image frame can be preferably different from a reused frequency of the third reused image frame. For example, the fused image frame can be generated as follows:

$$\begin{matrix}O [ i ] = Fus ( E 0 [ i ] , E 1 [ i ] , E 2 [ i + 2 ] ) \\ O [ i + 1 ] = Fus ( E 0 [ i ] , E 1 [ i + 1 ] , E 2 [ i + 2 ] ) \\ O [ i + 2 ] = Fus ( E 0 [ i + 2 ] , E 1 [ i + 2 ] , E 2 [ i + 2 ] ) \\ O [ i + 3 ] = Fus ( E 0 [ i + 2 ] , E 1 [ i + 3 ] , E 2 [ i + 5 ] ) \\ O [ i + 4 ] = Fus ( E 0 [ i + 4 ] , E 1 [ i + 4 ] , E 2 [ i + 5 ] ) \\ O [ i + 5 ] = Fus ( E 0 [ i + 4 ] , E 1 [ i + 5 ] , E 2 [ i + 5 ] )\end{matrix}$$

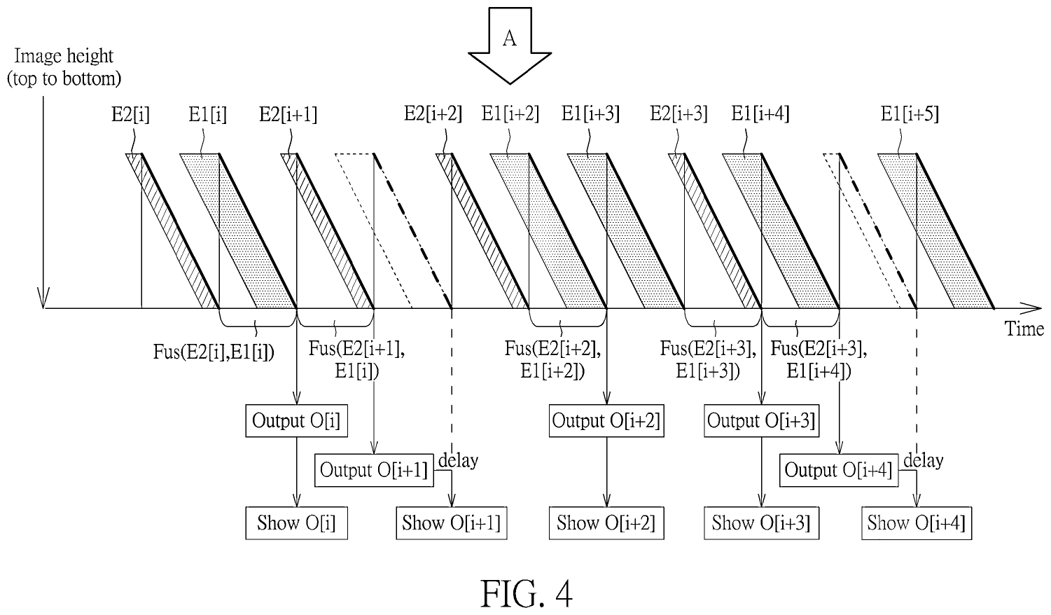

In some possible situation, the base exposure setting may be triggered and changed by scene change detected, setting changed by the user, camera vibration detected, and so on when video streaming, which means some event may trigger the base exposure setting from the second image stream E2 to the first image stream E1. Please refer to FIG. 4. FIG. 4 is a diagram of showing the image streams with different frame rates and different exposure settings according to a second embodiment of the present invention. The second embodiment can be applied for the high-speed camera sensor 14. The first frame rate of the first image stream E1 can be changed to be equal to the output frame rate of the output image stream O at a specific point of time, and the second frame rate of the second image stream E2 can be changed to be different from the output frame rate of the output image stream O at the same point of time.

As shown in FIG. 4, the second image stream E2 can have the base exposure setting and the first image stream E1 can have the reference exposure setting for a start, so the first reused image frame E1[i] can be fused with the second image frames E2[i] and E2[i+1] to output the fused image frames O[i] and O[i+1]; the fused image frame O[i] is output and shown immediately, and the fused image frame O[i+1] may be shown after delaying the predefined period. Then, the first image frame E1[i+2] are fused with the second image frame E2[i+2], and the base exposure setting is triggered and changed to the first image stream E1. Then, a trigger to change (for example, change the base exposure setting to the first image stream E1) is received at the time indicated by an arrow A, the first image frame E1[i+3] can be received before a second reused image frame E2[i+3], and the second reused image frame E2[i+3] can be fused with the first image frame E1[i+3] and the first image frame E1[i+4] respectively for outputting the fused image frames O[i+3] and O[i+4]; the fused image frame O[i+3] is output and shown immediately, and the fused image frame O[i+4] can be shown after delaying the predefined period.

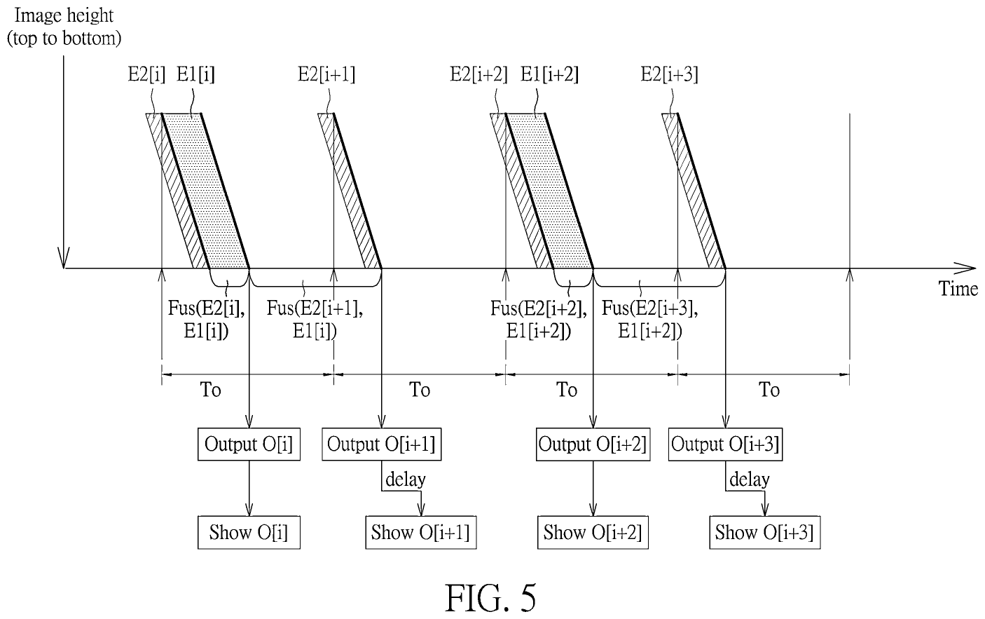

Please refer to FIG. 5. FIG. 5 is a diagram of showing the image streams with different frame rates and different exposure settings according to a third embodiment of the present invention. The third embodiment can be applied for the group exposure setting camera sensor 14, which has the group exposure setting designed for HDR. The third embodiment applied to the group exposure setting camera sensor 14 can change a number of the captured image frames in each group. The second image stream E2 can be selected as the base exposure setting, and the first image stream E1 can be selected as the reference exposure setting. The first reused image frame E1[i] can be fused with the second image frame E2[i] to output the fused image frame O[i], and then the first reused image frame E1[i] needs to be buffered for fusing with the second image frame E2[i+1] to output the fused image frame O[i+1]; the fused image frame O[i] is output and shown immediately, and the fused image frame O[i+1] may be shown after delaying the predefined period. Further, the first image frame E1[i+2] can be fused with the second image frames E2[i+2] and E2[i+3]; the fused image frame O[i+2] is output and shown immediately, and the fused image frame O[i+3] may be shown after delaying the predefined period.

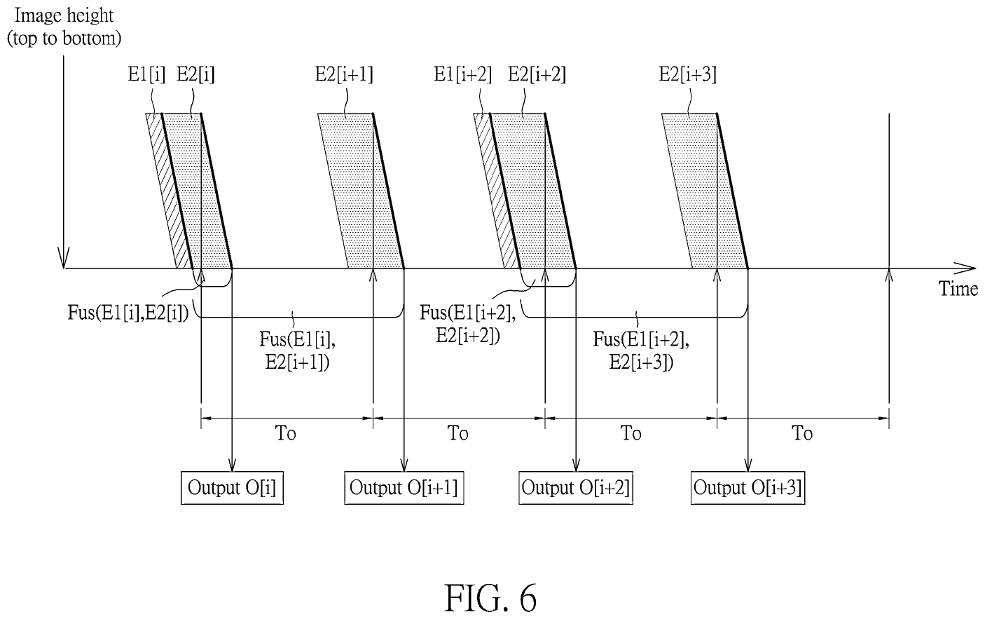

Please refer to FIG. 6. FIG. 6 is a diagram of showing the image streams with different frame rates and different exposure settings according to a fourth embodiment of the present invention. The fourth embodiment can be applied for the group exposure setting camera sensor 14. As shown in FIG. 6, the second image stream E2 which has the second exposure of the group setting can be selected as the base exposure setting, and the first image stream E1 can be selected as the reference exposure setting; the frame synchronous timing is set to the read-out timing of second image stream E2 for keep the interval between the captured image frames equally. Besides, the base exposure setting of the second image stream E2 can be changed because auto-exposure (AE) control may cause the exposure setting dynamically change. The first reused image frame E1[i] can be fused with the second image frames E2[i] and E2[i+1] to output the fused image frames O[i] and O[i+1]. Because the read-out timing of the second image stream E2 is the captured synchronous timing, the AE control does not change timing of the fused image frame, so the fused image frames O[i] and O[i+1] can be output and show immediately. Motion of the fused image frames O are aligned to the second image stream E2 with the base exposure setting.

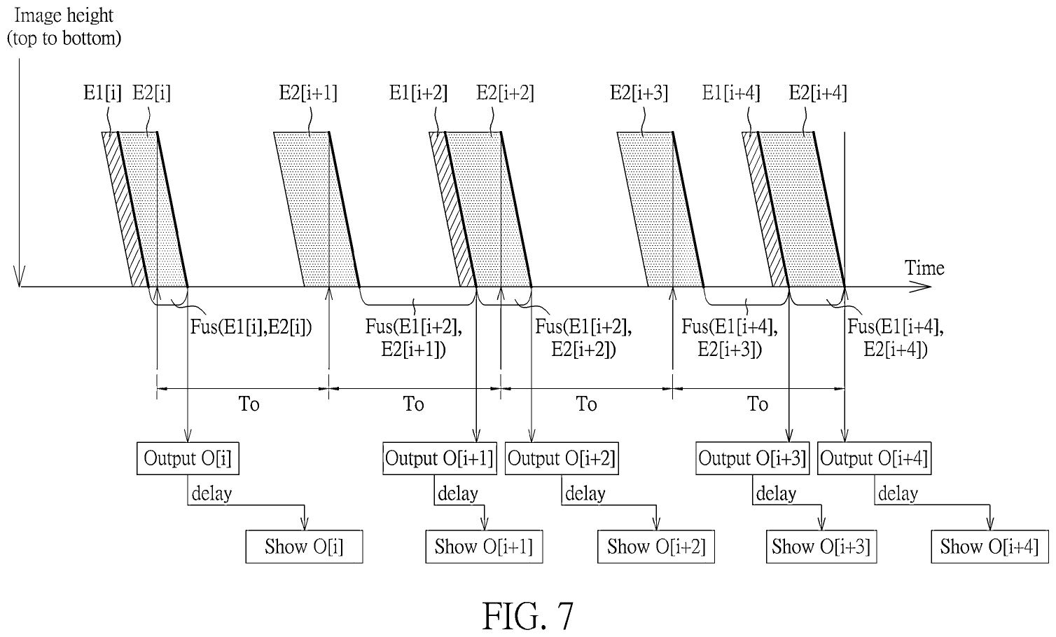

Please refer to FIG. 7. FIG. 7 is a diagram of showing the image streams with different frame rates and different exposure settings according to a fifth embodiment of the present invention. The fifth embodiment can be applied for the group exposure setting camera sensor 14. The second image stream E2 which has the second exposure of the group setting can be selected as the base exposure setting, and the first image stream E1 can be selected as the reference exposure setting. In the fifth embodiment, the reused image frame can be shared forward instead of the backward example as mentioned above. The previous second image frame E2[i+1] can be buffered to wait the first reused image frame E1[i+2] being captured, and then the first reused image frame E1[i+2] can be fused with the previous second image frame E2[i+1] to output the previous fused image frame O[i+1], and the first reused image frame E1[i+2] can be further fused with the current second image frame E2[i+2] to output the current fused image frame O[i+2]. The asymmetric image fusion method may delay a short predefined period to show the previous fused image frame O[i+1], and delay a long predefined period to show the current fused image frame O[i+2]. Therefore, all the fused image frames can be buffered to control the display speed of the output image stream O because the AE control may change the timing of the first image stream E1.

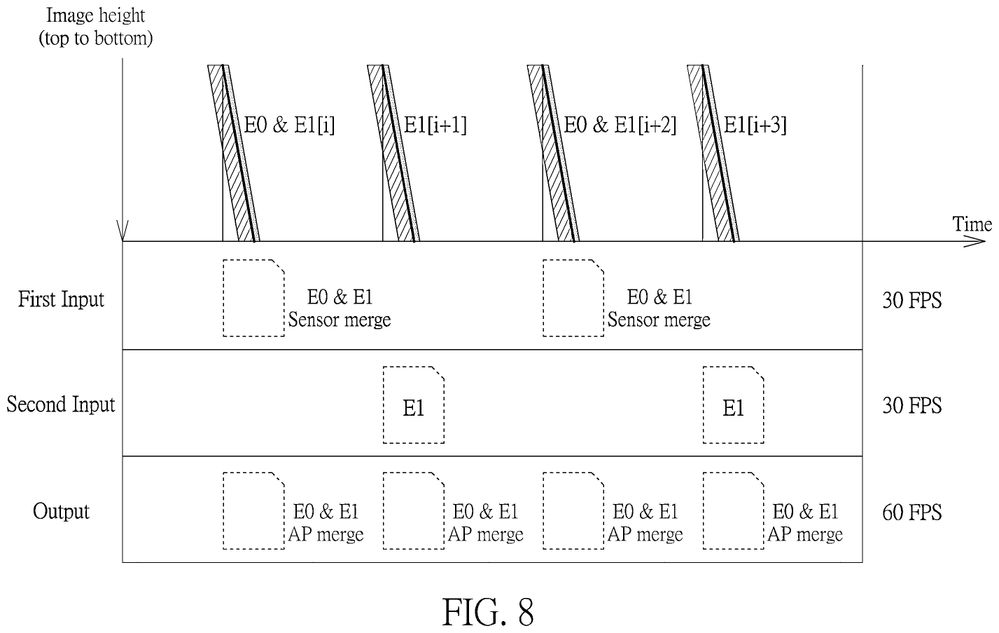

Please refer to FIG. 8. FIG. 8 is a diagram of showing the image streams with different frame rates and different exposure settings according to an embodiment of the present invention, which illustrates the implicit asymmetric frame rate HDR method. The diagram shows the timing relationships between input image streams and the output image stream.

In this embodiment, two image streams are input to the operation processor. The first input image stream comprises alternating frames of sensor-merged data (labeled as E0 & E1) and frames without sensor-merged data. The second input image stream comprises frames having data with one type of exposure setting (labeled as E1). Both input image streams may have a frame rate of 30 frames per second (fps), which is lower than the output frame rate of 60 fps.

The first input image stream comprises frames wherein odd-indexed frames contain sensor-merged data combining first exposure setting E0 and second exposure setting E1. For instance, frame E0[i] comprises sensor-merged data from both exposure settings. The second input image stream comprises frames having data from the second exposure setting E1, such as frame E1[i+1]. Accordingly, exposure setting E0 yields an effective 30 fps, whereas E1 achieves 60 fps by being present in both streams.

It should be noted that the frame rates of 30 fps for input streams and 60 fps for output stream are merely exemplary, and the present invention may be implemented with other suitable frame rates depending on the application requirements and system capabilities.

For generating the output image stream, the operation processor may perform fusion in two different ways depending on the frame index. For some output frames (e.g., odd-indexed output frames), the processor directly outputs the sensor-merged data from the first input stream. For some output frames (e.g., even-indexed output frames), the processor performs application processor (AP) merge between the previous sensor-merged frame from the first input stream and the current frame from the second input stream. For example, output frame O[i] comprises the sensor-merged data from frame E0&E1[i] of the first input stream, while output frame O[i+1] is generated by performing AP merge between frame E0&E1[i] from the first input stream and frame E1[i+1] from the second input stream.

This configuration maintains a one-frame timecode offset between the two input streams and enables efficient generation of HDR video at 60 fps output frame rate while reducing the required data transmission from the sensor by utilizing sensor-side merged exposures for odd-indexed frames. The timing diagram illustrates how the frames from both input streams are utilized to generate a continuous stream of HDR output frames while maintaining consistent frame timing and exposure information.

In some embodiments, maintaining a strict one-frame timecode offset between the two input streams is not necessary. The operation processor may receive the two input streams with varying timing offsets between corresponding frames, as long as at least one image frame of the first image stream has a timing offset from at least one image frame of the second image stream. For example, the timing offset may vary during operation due to factors such as sensor timing variations, processing delays, or intentional timing adjustments. The operation processor can accommodate such timing variations by appropriately buffering and synchronizing the frames from both input streams to maintain the desired output frame rate. This flexibility in timing relationships allows the system to operate effectively under various operating conditions while still achieving the benefits of reduced data transmission and efficient HDR video generation.

In certain embodiments, the image frames from different streams may comprise different image sizes. For example, the image frame E0[i] of the first exposure setting may comprise a different image size than the image frame E1[i] of the second exposure setting. Specifically, the image frame E0[i] may comprise a larger image size than the image frame E1[i], or alternatively, the image frame E0[i] may comprise a smaller image size than the image frame E1[i]. The specific size relationship between frames of different exposure settings may be determined based on application requirements, processing capabilities, or desired image quality characteristics or may be pre-defined.

Similarly, in embodiments utilizing sensor-merged frames, the sensor-merged frame E0&E1[i] comprising data from multiple exposure settings may comprise a different image size than the frame E1[i] comprising data from a single exposure setting. In particular implementations, the sensor-merged frame E0&E1[i] may comprise a larger image size than the frame E1[i], or alternatively, the sensor-merged frame E0&E1[i] may comprise a smaller image size than the frame E1[i]. The relative sizes of these frames may be configured according to the specific requirements of the imaging application, available transmission bandwidth, or processing constraints of the imaging system or may be pre-defined. The present invention provides several significant advantages over conventional HDR video technologies. First, by utilizing sensor-side merged exposure data in combination with asymmetric frame timing, the invention achieves substantial reduction in data transmission requirements between the sensor and the image processor. The data transmission can be significantly reduced compared to conventional methods that require transmission of separate exposure frames, thereby significantly reducing power consumption during sensing, transmission, and storage operations. Second, the invention maintains high output frame rates while requiring lower input frame rates from the sensor, which further contributes to power efficiency. Third, the invention's flexible architecture allows seamless switching of base exposure settings between image streams based on scene conditions or recording requirements, enabling optimal HDR capture across diverse shooting scenarios. Fourth, the timing offset between input streams enables efficient frame reuse while maintaining consistent output quality, eliminating the need for additional frame buffering in many cases. Moreover, by implementing asymmetric frame rates implicitly through sensor-side merging rather than explicitly through different capture rates, the invention achieves better compatibility with existing sensor technologies while maintaining the benefits of asymmetric HDR capture. This approach also provides improved resilience to timing variations and sensor limitations compared to conventional HDR methods.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image fusion method, comprising:
receiving a first image stream with a first frame rate;
receiving a second image stream with a second frame rate, wherein at least one image frame of the first image stream has a timing offset from at least one corresponding image frame of the second image stream; and
fusing a first reused image frame of the first image stream with a set of second image frames of the second image stream respectively for outputting a set of fused image frames.

2. The method of claim 1, wherein the first frame rate is different from the second frame rate.

3. The method of claim 2, wherein:
the first image stream has the timing offset from the second image stream; and
the timing offset is one frame timecode.

4. The method of claim 1, wherein at least one image frame of the first image stream comprises data from a plurality of exposure settings.

5. The method of claim 4, wherein the plurality of exposure settings comprises a first exposure setting and a second exposure setting, and wherein the second image stream comprises data from the second exposure setting.

6. The method of claim 1, wherein the first frame rate and the second frame rate are each lower than an output frame rate of the set of fused image frames.

7. The method of claim 1, wherein fusing the first reused image frame comprises:
outputting the first reused image frame when the first reused image frame comprises merged exposure data.

8. The method of claim 1, wherein fusing the first reused image frame comprises:
performing exposure fusion between the first reused image frame and an image frame in the set of second image frames when the first reused image frame does not comprise merged exposure data.

9. The method of claim 1, wherein at least one image frame of the first image stream comprises a different image size than at least one image frame of the second image stream.

10. An image fusion device, comprising one or more processors configured to:
receive a first image stream with a first frame rate;
receive a second image stream with a second frame rate; and
fuse a first reused image frame of the first image stream with a set of second image frames of the second image stream respectively for outputting a set of fused image frames;
wherein at least one image frame of the first image stream has a timing offset from at least one corresponding image frame of the second image stream.

11. The device of claim 10, wherein the first frame rate is different from the second frame rate.

12. The device of claim 11, wherein:
the first image stream has the timing offset from the second image stream; and
the timing offset is one frame timecode.

13. The device of claim 10, wherein at least one image frame of the first image stream comprises data from a plurality of exposure settings.

14. The device of claim 13, wherein the plurality of exposure settings comprises a first exposure setting and a second exposure setting, and wherein the second image stream comprises data from the second exposure setting.

15. The device of claim 10, wherein the first frame rate and the second frame rate are each lower than an output frame rate of the set of fused image frames.

16. The device of claim 10, wherein to fuse the first reused image frame, the one or more processors are further configured to:
output the first reused image frame when the first reused image frame comprises merged exposure data.

17. The device of claim 10, wherein to fuse the first reused image frame, the one or more processors are further configured to:
perform exposure fusion between the first reused image frame and an image frame in the set of second image frames when the first reused image frame does not comprise merged exposure data.

18. The device of claim 10, wherein at least one image frame of the first image stream comprises a different image size than at least one image frame of the second image stream.
